(19) United States
(12) Patent Application Publication
(10) Pub. No.: US 2018/0192571 A1
(43) Pub. Date: Jul. 12, 2018

(54) AGRICULTURAL DEVICE WITH CHAIN SEGMENTS AND RELATED METHODS

(71) Applicant: Gulfcoast Nurseries, LLC, Labelle, FL (US)

(72) Inventor: James C. PAUL, Labelle, FL (US)

(21) Appl. No.: 15/403,617

(22) Filed: Jan. 11, 2017

(51) Int. Cl. A01B 39/18; A01B 39/08; A01B 39/22; A01B 63/16

(52) U.S. Cl. CPC A01B 39/18; A01B 63/16; A01B 39/22; A01B 39/085

(57) ABSTRACT

An agricultural device may include an elongate housing having first and second ends and defining a cavity between the first and second ends, and a rotating shaft extending longitudinally through the cavity of the elongate housing and coupled to the first and second ends. The agricultural device may include a mechanical gearbox coupled between the rotating shaft and a tractor, and chain segments coupled to the rotating shaft and being longitudinally spaced on the rotating shaft. The mechanical gearbox may be configured to spin the rotating shaft so that the chain segments extend and impact a ground surface.

### TECHNICAL FIELD

The present disclosure relates to the field of agricultural devices, and, more particularly, to an agricultural device and related methods.

### BACKGROUND

The agricultural industry is a large and robust industry worldwide. To meet worldwide demand for agricultural products, producers utilize numerous methods to maximize production in agricultural crops. For example, one technique includes removing unwanted growth (i.e. soil cultivation) around the base of crops to enhance growth and production. Typically, this is accomplished with the application of herbicide around the base of most crops.

Although there are effective herbicides, there are several drawbacks to their use. Firstly, the adaptation of herbicide resistant “super weeds” has reduced the effectiveness of many herbicides. Secondly, herbicides cannot be applied toward organic fields or directly over non-GMO crops. Thirdly, the application of herbicides may weaken the crop's natural defense, and application to crops prior to harvest may result in crop damage when contacted by spray drift or when absorbed from the soil by the plant's root system.

### SUMMARY

In view of the foregoing background, it is therefore an object of the present disclosure to provide an agricultural device that is efficient and robust.

This and other objects, features, and advantages in accordance with the present disclosure are provided by an agricultural device comprising an elongate housing having first and second ends and defining a cavity between the first and second ends, and a rotating shaft extending longitudinally through the cavity of the elongate housing and coupled to the first and second ends. The agricultural device includes a mechanical gearbox coupled between the rotating shaft and by means of a drive shaft to a tractor or other means of propulsion; including but not limited to, directly coupled to a hydraulic motor or driven pulley and a plurality of chain segments defined as three or more individual pieces interlinked allowing movement and flexibility but rigidly attached at both ends and coupled to the rotating shaft and being longitudinally spaced on the rotating shaft. The mechanical gearbox is configured to spin the rotating shaft so that the plurality of chain segments extend and impact a ground surface. Advantageously, unwanted growth around the base of crops can be readily removed without damage to the agricultural device or the roots of the crop.

More specifically, the plurality of chain segments may also be radially spaced on the rotating shaft. The agricultural device may also include a guide wheel, and at least one arm coupled between the guide wheel and the elongate housing. The at least one arm may be configured to permit adjustment of a spacing between the ground surface and the elongate housing.

In some embodiments, the at least one arm comprises a first fixed arm and a second longitudinally adjustable arm. The mechanical gearbox may be adjacent the first end of the elongate housing, and the guide wheel may be adjacent the second end of the elongate housing. The elongate housing may comprise a semi-cylindrical housing, for example. The agricultural device may include a retractable arm coupled between the tractor and the elongate housing and configured to retract the elongate housing. The agricultural device may comprise an adjustable friction clutch coupled between the tractor and the mechanical gearbox.

Another aspect is directed to a cultivator system comprising a tractor, and an agricultural device. The agricultural device includes an elongate housing having first and second ends and defining a cavity between the first and second ends, a rotating shaft extending longitudinally through the cavity of the elongate housing and coupled to the first and second ends, and a mechanical gearbox coupled between the rotating shaft and the tractor. The agricultural device includes a plurality of chain segments coupled to the rotating shaft and being longitudinally spaced on the rotating shaft. The mechanical gearbox is configured to spin the rotating shaft so that the plurality of chain segments extend and impact a ground surface.

Another aspect is directed to a method of operating with an agricultural device. The agricultural device comprises an elongate housing having first and second ends and defining a cavity between the first and second ends, a rotating shaft extending longitudinally through the cavity of the elongate housing and coupled to the first and second ends, a mechanical gearbox coupled between the rotating shaft and a tractor, and a plurality of chain segments coupled to the rotating shaft and being longitudinally spaced on the rotating shaft. The method includes operating the tractor to position the agricultural device adjacent at least one row of crops, and to spin the rotating shaft so that the plurality of chain segments extend and impact a ground surface adjacent the at least one crop row.

### BRIEF DESCRIPTION OF THE DRAWINGS

FIG. 1 is a schematic diagram of a cultivator system, according to the present disclosure.

FIG. 2 is a schematic perspective view of an embodiment of an agricultural device from the cultivator system of FIG. 1.

FIG. 3 is a schematic diagram of a portion of the agricultural device from FIG. 2.

FIG. 4 is a schematic perspective view of the mechanical gearbox of the agricultural device from FIG. 2.

FIG. 5 is a schematic perspective view of a portion of the elongate housing and the mechanical gearbox of the agricultural device from FIG. 2.

FIG. 6 is a schematic perspective view of the mechanical gearbox of the agricultural device from FIG. 2.

FIGS. 7A-7D are schematic perspective views of portions of the agricultural device, according to another embodiment of the present disclosure.

### DETAILED DESCRIPTION

The present disclosure will now be described more fully hereinafter with reference to the accompanying drawings, in which several embodiments of the invention are shown. This present disclosure may, however, be embodied in many different forms and should not be construed as limited to the embodiments set forth herein. Rather, these embodiments are provided so that this disclosure will be thorough and complete, and will fully convey the scope of the present disclosure to those skilled in the art. Like numbers refer to like elements throughout, and prime notation is used to indicate similar elements in alternative embodiments.

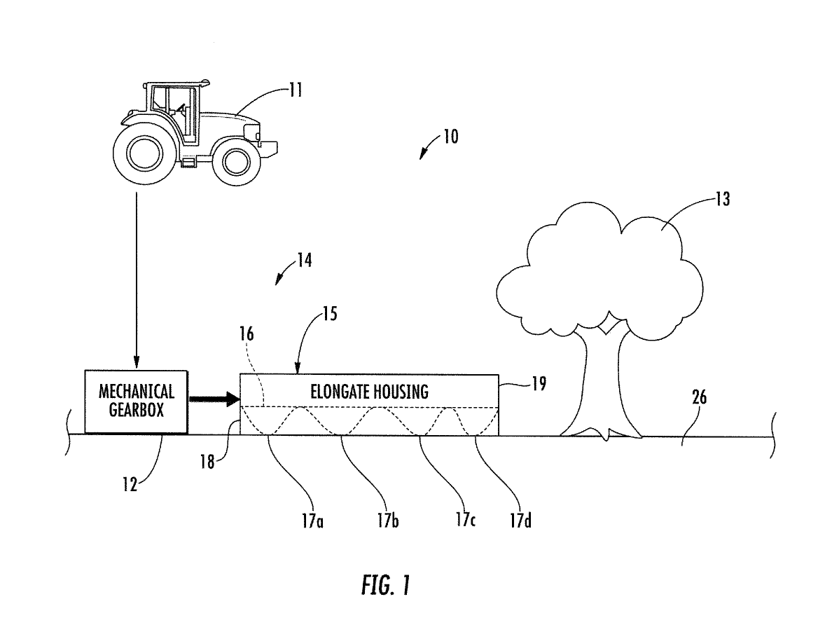

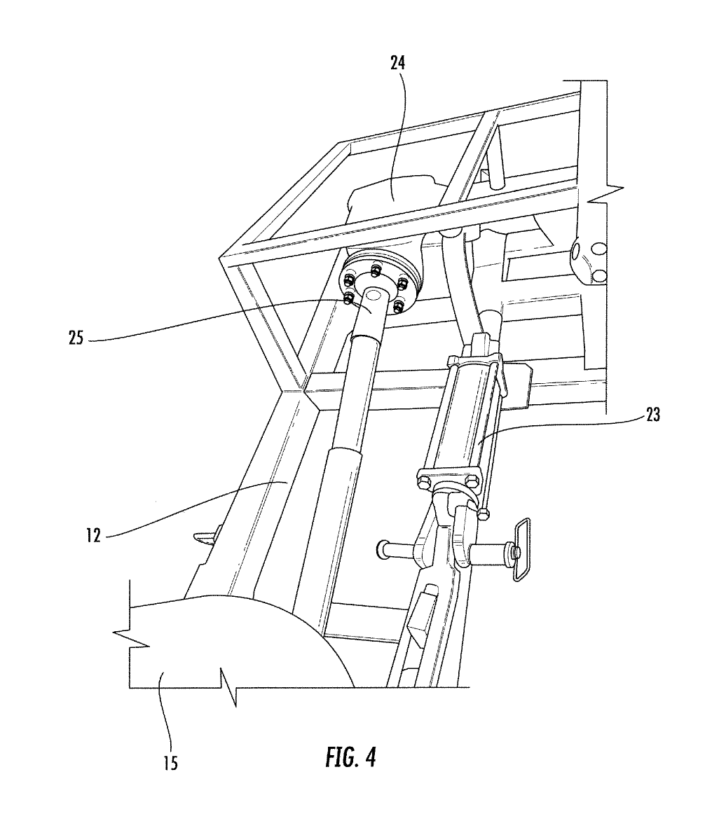

Referring to FIGS. 1-5, a cultivator system 10 according to the present disclosure is now described. The cultivator system 10 illustratively includes a tractor 11, and an agricultural device 14 coupled to the tractor. As will be appreciated by the skilled person, the tractor 11 provides mechanical power for the agricultural device 14.

The agricultural device (e.g. a cultivator device) 14 cultivates or tills a ground surface 26 adjacent a row of crops or boundary such as a fence 13, i.e. removing unwanted growth. In the illustrated embodiment, only one crop row 13 is shown for ease of illustration, but the skilled person will appreciate application to a large farm or fence rows, nature trails, etc. In some typical cultivation devices, spinning blades are used to cultivate the soil adjacent to crops. These approaches may suffer from several issues, such as damage to root structures. Also, typical blade based devices may be damaged if the soil contains large rocks.

The agricultural device 14 includes an elongate housing (i.e. a tractor boom) 15 having first and second ends 18, 19 and defining a cavity between the first and second ends. The elongate housing 15 illustratively includes first and second longitudinal sides extending between the first and second ends 18, 19, the first longitudinal side opposite the ground surface being closed. The elongate housing 15 may comprise hardened steel, but in some embodiments, a polymer of sufficient mechanical durability could be used.

The agricultural device 14 includes a rotating shaft (or a drive shaft) 16 extending longitudinally through the cavity of the elongate housing 15 and coupled to the first and second ends 18, 19, and a mechanical gearbox 12 coupled between the rotating shaft and the tractor 11. The mechanical gearbox 12 comprises a 90 degree gearbox 24 and transmits the mechanical power from the tractor 11 to the rotating shaft 16, spinning the rotating shaft at 700-2000 revolutions per minute (RPM) (e.g. 1000 RPM).

The agricultural device 14 includes a plurality of chain segments 17a-17g coupled to the rotating shaft 16 and being longitudinally spaced on the rotating shaft, i.e. being spaced between the first and second ends 18, 19. In some embodiments, the plurality of chain segments 17a-17g comprises hardened steel or some other material of sufficient density and rigidity being three or more individual pieces securely interlinked allowing movement and flexibility but rigidly attached at both ends. The plurality of chain segments 17a-17g is coupled to the rotating shaft 16 via a weld in some embodiments. In other embodiments, the rotating shaft 16 may include threaded openings, and the plurality of chain segments 17a-17g is coupled to the rotating shaft 16 via a threaded screw/washer or flanged fastening bolt arrangement. Helpfully, in flanged bolt embodiments, worn chain segments can be easily replaced in the field if needed.

The mechanical gearbox 12 is configured to spin the rotating shaft 16 so that the plurality of chain segments 17a-17g extend and impact the ground surface 26. The elongate housing 15 extends out transverse to the path of motion of the tractor 11 at an 80-100 degree offset (e.g. 90 degree) from the path of motion.

Advantageously, the plurality of chain segments 17a-17g moves at high speed and removes growth from the ground surface 26. Also, since the chain segments 17a-17g are flexible by their very design, they are able to process rocks and other rigid items in the soil of the ground surface 26 with little to no damage.

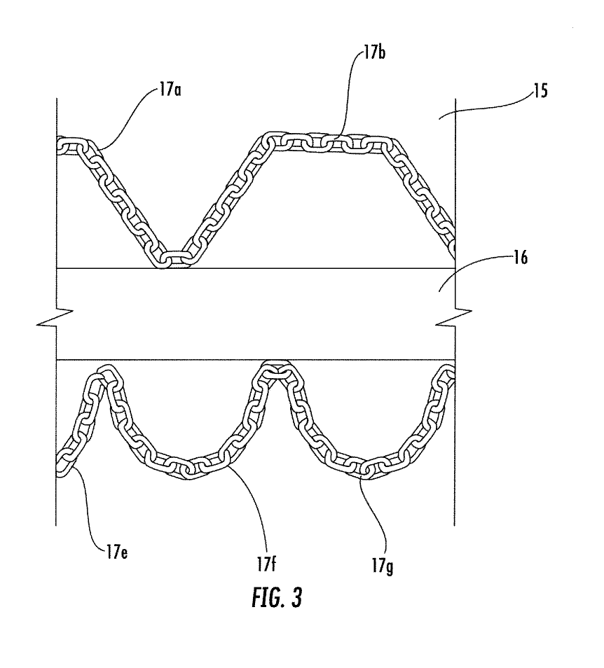

As perhaps best seen in FIG. 3, the plurality of chain segments 17a-17g is also radially spaced on the rotating shaft 16. In some embodiments, the radial spacing may be the illustrated 180 degrees or 90 degrees, for example. In some embodiments, the plurality of chain segments 17a-17g comprises a plurality of subsets of chain segments, each subset of chain segments comprising a different length and/or spacing on the rotating shaft 16, there-by permitting flexibility in cultivating the ground surface depending on crop or specific application 26.

The agricultural device 14 illustratively includes a guide wheel 20, a first fixed arm 22 coupled between the guide wheel and the elongate housing 15, and a second longitudinally adjustable arm 21 coupled between the guide wheel and the elongate housing. The second longitudinally adjustable arm 21 is configured to permit adjustment of a spacing between the ground surface 26 and the elongate housing 15, thereby adjusting the depth that the plurality of chain segments 17a-17g cut into the ground surface. Advantageously, this may prevent damage to shallow rooted plants during cultivation.

The mechanical gearbox 12 is illustratively adjacent the first end 18 of the elongate housing 15, and the guide wheel 20 is illustratively adjacent the second end 19 of the elongate housing. In some embodiments, the agricultural device 14 may include a plurality of guide wheels, for example, positioned at opposite first and second ends 18, 19 of the elongate housing 15.

In the illustrated embodiment, the elongate housing 15 comprises a semi-cylindrical housing, for example. In other embodiments, the elongate housing 15 may take on other geometric/irregular shapes (e.g. pyramid, rectangular box), so long at it shields the tractor 11 and user from debris from the ground surface 26. The curved elongate housing 15 embodiments may helpfully prevent adjacent crops from entanglement during operation, thereby preventing damage to the crop and avoiding risk to the user.

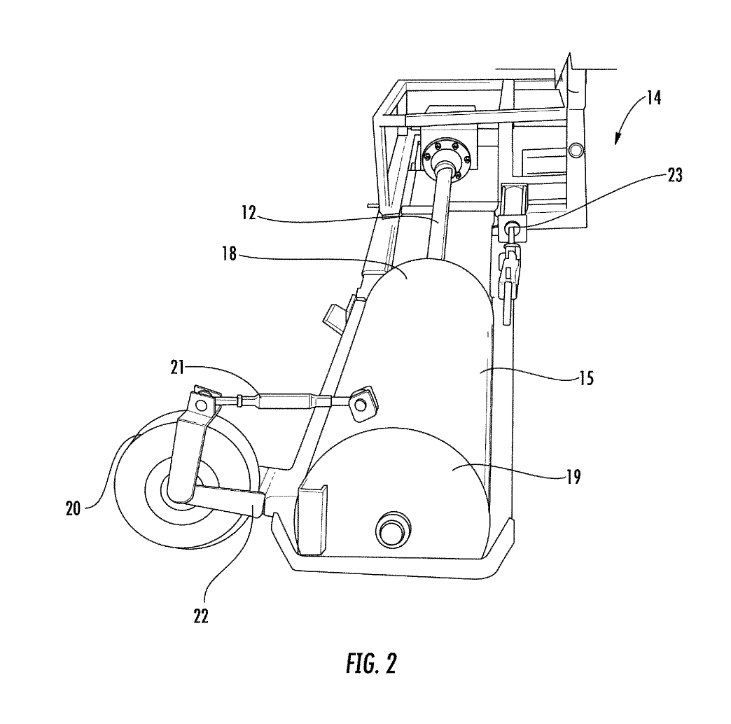

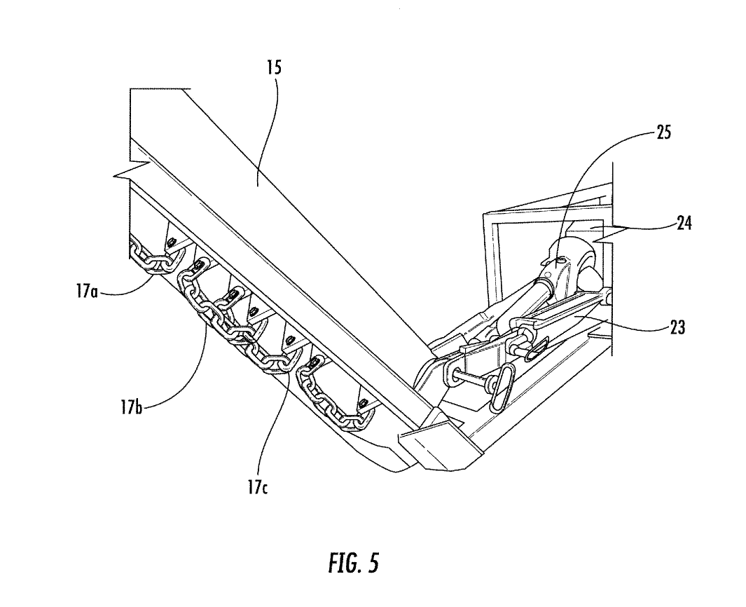

As perhaps best seen in FIGS. 2 and 5, the agricultural device 14 illustratively includes a retractable arm (e.g. hydraulic arm) 23 coupled between the tractor 11 and the elongate housing 15 and configured to retract the elongate housing (FIG. 5). In the retracted state, the tractor 11 is more readily maneuvered. In hydraulic embodiments, the tractor 11 will provide hydraulic power for this feature.

Moreover, the agricultural device 14 illustratively includes an adjustable friction clutch 25 coupled between the tractor 11 and the mechanical gearbox 12. The adjustable friction clutch 25 may helpfully protect the drivetrain from damage when debris is lodged within the elongate housing 15.

Another aspect is directed to a method of cultivating/operating with an agricultural device 14. The agricultural device 14 comprises an elongate housing 15 having first and second ends 18, 19 and defining a cavity between the first and second ends, a rotating shaft 16 extending longitudinally through the cavity of the elongate housing and coupled to the first and second ends, a mechanical gearbox 12 coupled between the rotating shaft and a tractor 11, and a plurality of chain segments 17a-17g coupled to the rotating shaft and being longitudinally spaced on the rotating shaft. The method includes operating the tractor 11 to position the agricultural device 14 adjacent at least one row of crops 13, and to spin the rotating shaft 16 so that the plurality of chain segments 17a-17g extend and impact a ground surface 26 adjacent the crop row.

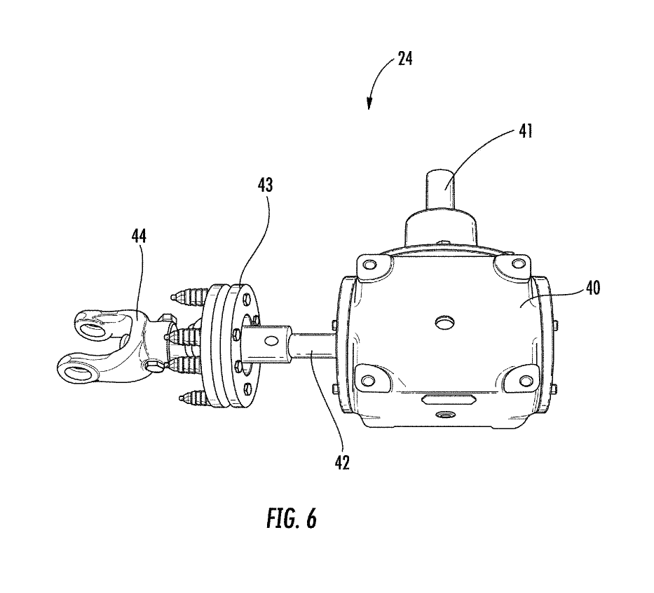

Referring now additionally to FIG. 6, the 90 degree gearbox 24 illustratively includes a first drive shaft 41 to be coupled to the tractor 11, a second drive shaft 42 to be coupled to the agricultural device 14, and a gear box housing 40 coupled between the first and second drive shafts and carrying a plurality of gears therein. The 90 degree gearbox 24 illustratively includes a radial plate (i.e. a clutch disc) 43 coupled to a distal end of the second drive shaft 42, and yoke 44 coupled to a distal end of the radial plate.

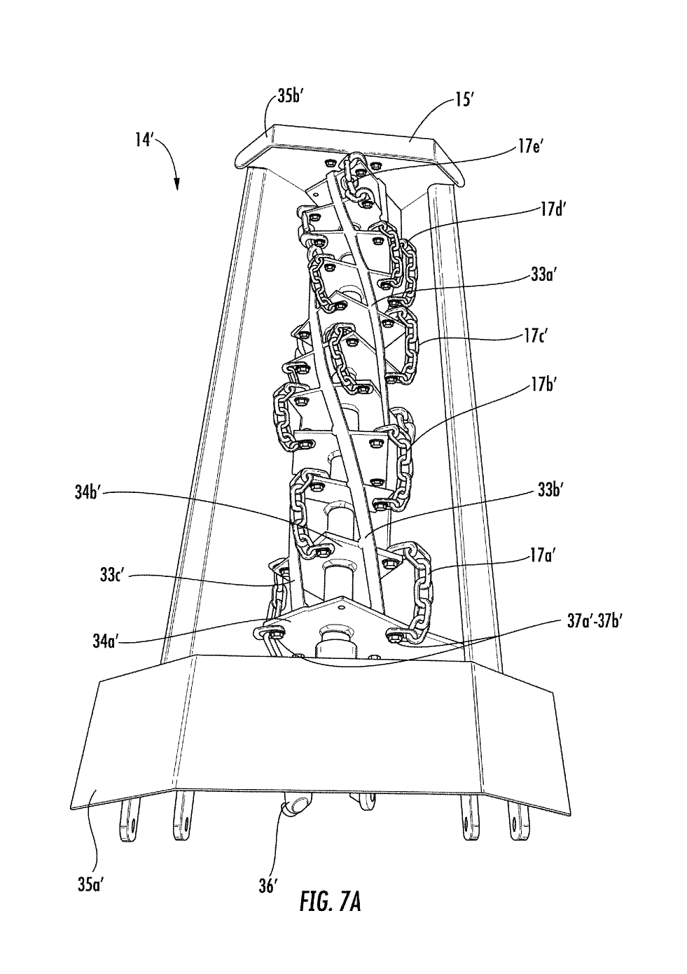

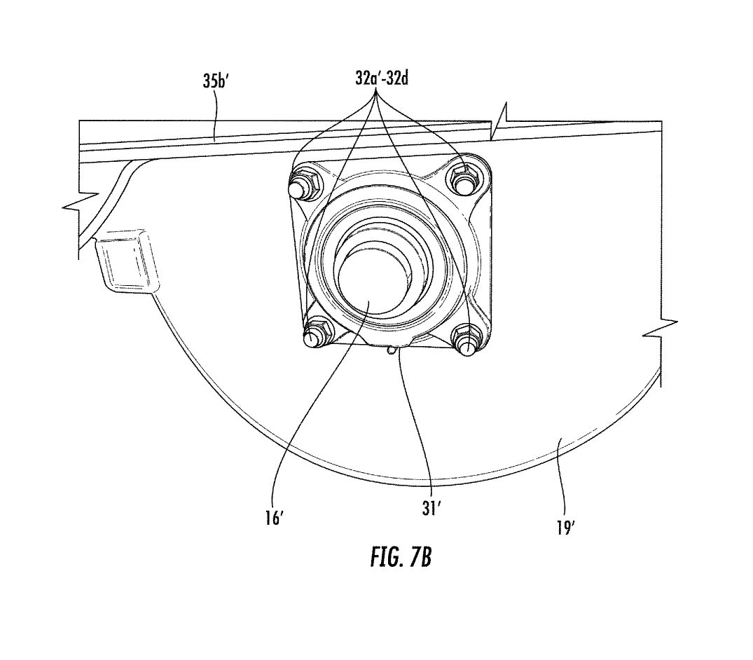

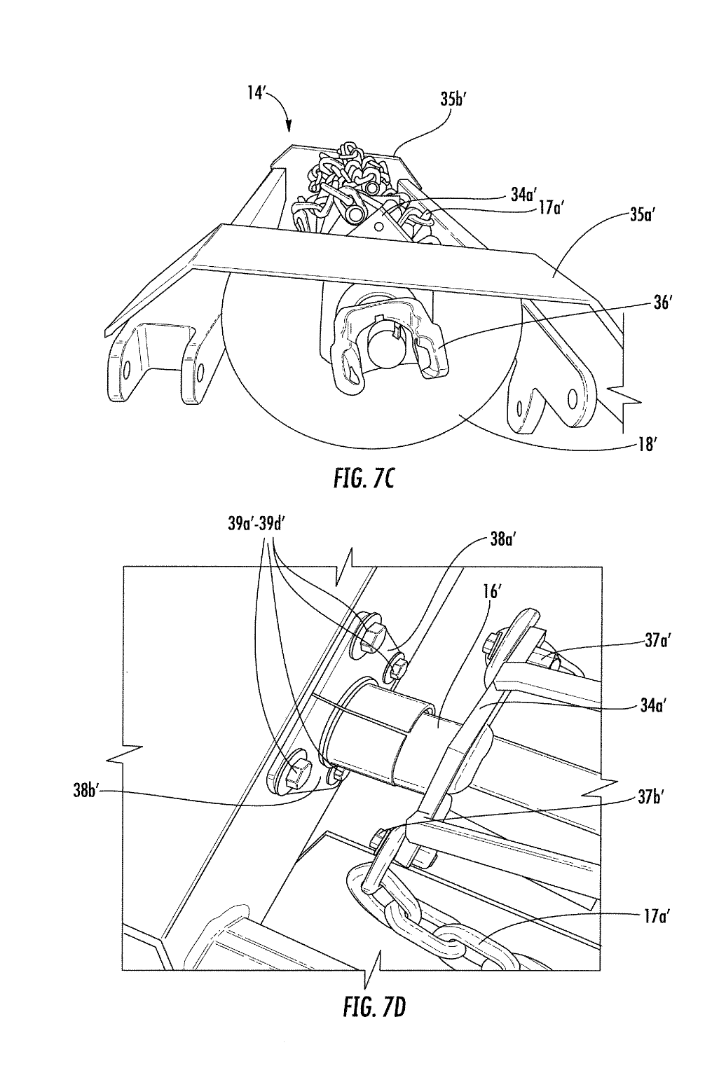

Referring now additionally to FIGS. 7A-7D, another embodiment of the agricultural device 14′ is now described. In this embodiment of the agricultural device 14′, those elements already discussed above with respect to FIGS. 1-6 are given prime notation and most require no further discussion herein. As perhaps best seen in FIG. 7B, this embodiment differs from the previous embodiment in that this agricultural device 14′ has the first end 18′ and second end 19′ defining an opening for receiving the rotating shaft 16′. The first and second ends 18′ and 19′ also illustratively include 4 bolt Flanged Roller Bearing 31′ for position (i.e. x, y, z positions) fixing the rotating shaft 16′, but permitting free rotational movement. The second end 19′ also illustratively includes a plurality of fastening bolts 32a′-32d′ for fixing the 4 bolt Flanged Roller Bearing 31′ to outer surfaces of the elongate housing 15′.

As perhaps best seen in FIG. 7A, this embodiment differs from the previous embodiment in that this agricultural device 14′ illustratively includes a plurality of flat plates 34a′-34b′ coupled (e.g. via a weld) to the rotating shaft 16′ in near (i.e. within ±5 degrees) perpendicular relation to the rotating shaft. In other embodiments, the plurality of flat plates 34a′-34b′ may be canted at an angle between 90 degrees and 45 degrees to the rotating shaft 16′ (i.e. merely positioned transverse to the rotating shaft). In the illustrated embodiment, the plurality of flat plates 34a′-34b′ shift radial position on the rotating shaft 16′ as they progress longitudinally, but in other embodiments, they could be radially aligned and equal. Hence, the plurality of chain segments 17a′-17d′ are also illustratively radially shifted, i.e. they are canted to the longitudinal axis of the rotating shaft 16′.

The agricultural device 14′ illustratively includes a plurality of longitudinal cross braces 33a-33c′ extending along a length of the rotating shaft 16′ and being coupled (e.g. via a weld) to distal ends of the plurality of flat plates 34a′-34b′. The plurality of longitudinal cross braces 33a′-33c′ provides structural support to the plurality of flat plates 34a′-34b′. Each of the plurality of longitudinal cross braces 33a′-33c′ has a radial displacement as it progress longitudinally down the rotating shaft 16′ (i.e. they curl/spiral around the rotating shaft). In other embodiments, the plurality of longitudinal cross braces 33a′-33c′ may omit the curling and extend substantially parallel (i.e. straight) to the rotating shaft 16′.

Also, in this illustrated embodiment, the plurality of chain segments 17a′-17d′ are coupled to distal corners of the plurality of flat plates 34a′-34b′ via a plurality of fastening bolts 37a′-37b′ (welds could be used in other embodiments), which permits replacement of worn chain segments 17a′-17d′ with ease. The agricultural device 14′ illustratively includes a first and second skid plates 35a′-35b′ respectively coupled to the first and second ends 18′, 19′ and configured to provide a maximum depth of operation.

As perhaps best seen in FIGS. 7C and 7D, this embodiment differs from the previous embodiment in that this agricultural device 14′ illustratively includes the first end 18′ comprising a coupler (i.e. a yoke) 36′ configured to be driven by the power supplying yoke by means of uniting these two yokes with a universal joint 44 (FIG. 6). The agricultural device 14′ illustratively includes first and second shield plates 38a′-38b′ for shielding the 4 bolt Flanged Roller Bearings affixed to the outer surfaces of the first end 18′ and second end 19′ of the elongate housing 15′. As will be appreciated, the rotating shaft 16′ is attached to the outer surfaces of the first end 18′ and second end 19′ of the elongate housing 15′ via a 4 bolt Flanged Roller Bearing arrangement, and the first and second shield plates 38a′-38b′ prevent debris from damaging the bearing arrangement. The first and second shield plates 38a′-38b′ are disjointed separate components, which permit easy assembly. The first and second shield plates 38a′-38b′ are fixed via a plurality of fastening bolts 32a′-32d′ which extend through the first end 18′ and second end 19′ where they also attach the 4 bolt Flanged Roller Bearings to the outer surface of said first end 18′ and second end 19′ thereby positioning and fixing the rotating shaft 16′ within the elongate housing 14′.

Many modifications and other embodiments of the present disclosure will come to the mind of one skilled in the art having the benefit of the teachings presented in the foregoing descriptions and the associated drawings. Therefore, it is understood that the present disclosure is not to be limited to the specific embodiments disclosed, and that modifications and embodiments are intended to be included within the scope of the appended claims.

That which is claimed is:

1. An agricultural device comprising:
an elongate housing having first and second ends and defining a cavity between the first and second ends;
a rotating shaft extending longitudinally through the cavity of said elongate housing and coupled to said first and second ends;
a mechanical gearbox coupled between said rotating shaft and a tractor; and
a plurality of chain segments coupled to said rotating shaft and being longitudinally spaced on said rotating shaft;
said mechanical gearbox configured to spin said rotating shaft so that said plurality of chain segments extend and impact a ground surface.

2. The agricultural device of claim 1 wherein said plurality of chain segments is also radially spaced on said rotating shaft.

3. The agricultural device of claim 1 further comprising a guide wheel, and at least one arm coupled between said guide wheel and said elongate housing; and wherein said at least one arm is configured to permit adjustment of a spacing between the ground surface and said elongate housing.

4. The agricultural device of claim 3 wherein said at least one arm comprises a first fixed arm and a second longitudinally adjustable arm.

5. The agricultural device of claim 3 wherein said mechanical gearbox is adjacent the first end of said elongate housing; and wherein said guide wheel is adjacent the second end of said elongate housing.

6. The agricultural device of claim 1 wherein said elongate housing comprises a semi-cylindrical housing.

7. The agricultural device of claim 1 further comprising a retractable arm coupled between the tractor and said elongate housing and configured to retract said elongate housing.

8. The agricultural device of claim 1 further comprising an adjustable friction clutch coupled between the tractor and said mechanical gearbox.

9. A cultivator system comprising:
a tractor; and
an agricultural device comprising
an elongate housing having first and second ends and defining a cavity between the first and second ends,
a rotating shaft extending longitudinally through the cavity of said elongate housing and coupled to said first and second ends,
a mechanical gearbox coupled between said rotating shaft and said tractor, and
a plurality of chain segments coupled to said rotating shaft and being longitudinally spaced on said rotating shaft,
said mechanical gearbox configured to spin said rotating shaft so that said plurality of chain segments extend and impact a ground surface.

10. The cultivator system of claim 9 wherein said plurality of chain segments is also radially spaced on said rotating shaft.

11. The cultivator system of claim 9 wherein said agricultural device comprises a guide wheel, and at least one arm coupled between said guide wheel and said elongate housing; and wherein said at least one arm is configured to permit adjustment of a spacing between the ground surface and said elongate housing.

12. The cultivator system of claim 11 wherein said at least one arm comprises a first fixed arm and a second longitudinally adjustable arm.

13. The cultivator system of claim 11 wherein said mechanical gearbox is adjacent the first end of said elongate housing; and wherein said guide wheel is adjacent the second end of said elongate housing.

14. The cultivator system of claim 9 wherein said elongate housing comprises a semi-cylindrical housing.

15. The cultivator system of claim 9 wherein said agricultural device comprises a retractable arm coupled between said tractor and said elongate housing and configured to retract said elongate housing.

16. A method of operating with an agricultural device comprising an elongate housing having first and second ends and defining a cavity between the first and second ends, a rotating shaft extending longitudinally through the cavity of the elongate housing and coupled to the first and second ends, a mechanical gearbox coupled between the rotating shaft and a tractor, and a plurality of chain segments coupled to the rotating shaft and being longitudinally spaced on the rotating shaft, the method comprising:
operating the tractor to position the agricultural device adjacent at least one row of crops, and to spin the rotating shaft so that the plurality of chain segments extend and impact a ground surface adjacent the crop row.

17. The method of claim 16 wherein the plurality of chain segments is also radially spaced on the rotating shaft.

18. The method of claim 16 wherein the agricultural device comprises a guide wheel, and at least one arm coupled between the guide wheel and the elongate housing; and further comprising adjusting a spacing between the ground surface and the elongate housing.

19. The method of claim 18 wherein the at least one arm comprises a first fixed arm and a second longitudinally adjustable arm.

20. The method of claim 16 wherein the agricultural device comprises a retractable arm coupled between the tractor and the elongate housing; and further comprising retracting the elongate housing away from the ground surface using the retractable arm.
